(19) United States
(12) Patent Application Publication
(10) Pub. No.: US 2017/0046731 A1
(43) Pub. Date: Feb. 16, 2017

(54) ADVERTISEMENT SERVING OPTIMIZATION SYSTEM FOR OPTIMIZING SERVING OF ADVERTISEMENTS

(71) Applicant: SVG Media Pvt Ltd, New Delhi (IN)

(72) Inventors: Udit SARIN, Gurgaon (IN); Vaibhav PANDEY, Gurgaon (IN); Prabha KUMARI, Gurgaon (IN); Siddharth PURI, Gurgaon (IN)

(21) Appl. No.: 14/945,346

(22) Filed: Nov. 18, 2015

(30) Foreign Application Priority Data
Aug. 12, 2015 (IN) 2481/DEL/2015

(51) Int. Cl. G06Q 30/02

(52) U.S. Cl. CPC G06Q 30/0242; G06Q 30/0273

(57) ABSTRACT

The present disclosure provides a method and system for facilitating optimized serving of one or more advertisements on one or more publishers. The advertisement serving optimization system includes a fetching module configured for fetching a first set of parameters associated with one or more advertisers, the one or more publishers and the one or more advertisements associated with the one or more advertisers; a calculation module configured to calculate a probabilistic effective cost per thousand impressions value for a second set of parameters based on the first set of parameters; a priority setting module configured for ranking each of the plurality of advertisement campaigns associated with the corresponding one or more advertisers and an advertisement serving module configured to serve the one or more advertisements to one or more users on the corresponding one or more publishers based on the ranking of each of the plurality of advertisement campaigns.

### TECHNICAL FIELD

The present disclosure relates to the field of electronic advertising. More specifically, the present relates to enabling optimized serving of one or more advertisements to one or more users by assessing performance of the one or more advertisements.

### BACKGROUND

With the advent of technological advancements in the last few years, online advertising has evolved into a topmost advertising medium. Nowadays, a substantial amount of users spend theft time browsing through the internet through their portable communication devices for various activities. A wide range of information is available today on the web about the users through various technologies employed by online publishers. This information is crucial for running the advertising business effectively. Moreover, the tendency of the users to consistently indulge in the internet has been leveraged by advertisers and publishers for effectively serving advertisements to the users for generating and sharing revenue between each other.

Traditionally, the advertisements are served to the users on their corresponding communication devices by various advertisers. These advertisements are specifically targeted to each user based on their online behavior and profile. The prime purpose of serving targeted advertisements is to generate revenue by enticing the users to click or take any action after viewing the advertisement. In general, numerous entities have surfaced in the market specifically employed for running advertising related operations. These entities include various advertisement supplying intermediaries including advertisement exchanges, advertisement networks, affiliates, advertisement agencies and the like. The objective of these entities is to assist the advertisers in determining a specific set of advertisements which when displayed to the users would help in generating maximum revenue. Moreover, the advertisement supplying intermediaries link the advertisers and the publishers through a contract for delivering and displaying advertisements on their websites or applications.

Further, the advertisers associated with different domains run a number of advertisement campaigns on the internet for marketing their products and services through the one or more advertisements. These advertisement campaigns include various campaign goals that the advertisers wish to achieve. The advertisers want to provide the users with relevant advertisements. Furthermore, the advertisement supplying intermediaries run the advertisement campaigns for a large number of advertisers. The advertisement supplying intermediaries monitor the performance of each of the advertisement campaigns in real time.

Presently, the performance of the advertisement campaigns is typically adjudged by calculating an effective cost per thousand impressions for each type of advertisement which is displayed on the publisher website or the application. Ranking of the advertisements is done from a high effective cost per thousand impressions to low effective cost per thousand impressions. The display of advertisements with a higher effective cost per thousand impressions is assigned a higher priority than the advertisements with lower effective cost per thousand impressions as they are predicted to generate more revenues.

The present systems and methods for optimizing serving of the advertisements are inefficient. Moreover, the present systems and methods do not take into account performance of the advertisements on various publisher categories. In addition, the present systems and methods do not take into account daily goals of the advertisers in order to help the advertisers to achieve the desired result or revenue. Further, the present systems and methods do not rank the advertisement campaigns based on the effective cost per thousand impressions and the daily goals. Furthermore, the present systems and methods serve the same best performing advertisements on a consistent basis without taking into account the advertiser goals. Moreover, there is no such provision for adjusting target goal associated with the number of impressions for each advertisement which is desired based on the performance of the advertisements in real time.

In the light of the above stated discussion, there is a need for system that overcomes the above stated disadvantages.

### SUMMARY

In an aspect of the present disclosure, a computer-implemented method for facilitating optimized serving of one or more advertisements on one or more publishers is provided. The computer-implemented method includes fetching, with a processor, a first set of parameters associated with one or more advertisers, the one or more publishers and the one or more advertisements associated with the one or more advertisers; calculating, with the processor, a probabilistic effective cost per thousand impressions value for a second set of parameters based on the first set of parameters, ranking, with the processor, each of a plurality of advertisement campaigns associated with each of the one or more advertisers and serving, with the processor, the one or more advertisements to one or more users on the corresponding one or more publishers based on the ranking of each of the plurality of advertisement campaigns. The second set of parameters is associated with the one or more advertisers, the one or more publishers and the one or more advertisements associated with the one or more advertisers. The effective cost per thousand impressions is calculated for the one or more advertisements associated with the one or more advertisers. The rank is assigned based on the probabilistic effective cost per thousand impressions value and a third set of parameters associated with each of the plurality of advertisement campaigns. The ranking is performed for assigning a priority level to each of the plurality of advertisement campaigns. The priority is assigned based on weights. The served one or more advertisements corresponding to the one or more advertisers are associated with a corresponding one or more advertisements campaigns of the plurality of advertisement campaigns having a highest rank and priority. The one or more advertisements are served in real time.

In an embodiment of the present disclosure, the computer-implemented method further includes dynamically updating, with the processor, the first set of parameters, the second set of parameters, the third set of parameters and the rank of each of each of the plurality of advertisement campaigns. The updating is done in real time.

In an embodiment of the present disclosure, the first set of parameters includes at least one of a name of each of the one or more advertisers, an advertiser ID of each of the one or more advertisers, an advertiser category of each of the one or more advertisers, an advertiser campaign information for each of the one or more advertisers, an advertiser campaign ID for each of the one or more advertisers, a banner type, a banner ID for each of the one or more advertisements, a publisher ID for each of the one or more publishers, name of an operating system associated with a portable communication device accessed by a user of the one or more users, time of impression request by the one or more publishers, an operating system version of the portable communication device accessed by the user of the one or more users, a publisher category for each of the one or more publishers and a network ID. The advertiser category and the publisher category are determined by utilizing a binary identification.

In an embodiment of the present disclosure, the second set of parameters includes at least one of an effective cost per thousand impressions for each banner ID on each publisher of the one or more publishers, an effective cost per thousand impressions for each of the one or more advertisers on each of the one or more publishers, an effective cost per thousand impressions for each of the one or more advertisers on each of one or more publisher categories associated with each of the one or more publishers, an effective cost per thousand impressions for each of one or more advertiser categories associated with the one or more advertisers on each of the one or more publishers, an effective cost per thousand impressions for each of the one or more advertiser categories on each of the one or more publisher categories, an effective cost per thousand impressions for each of one or more banners IDs on each of the one or more publishers, an effective cost per thousand impressions for each of the one or more banner IDs on each of the one or more publisher categories, an effective cost per thousand impressions for each of the one or more advertisers on each of one or more networks, an effective cost per thousand impressions of each of the one or more banner IDs on each of the one or more networks, an effective cost per thousand impressions of each of the one or more advertiser categories on each of the one or more networks, an effective cost per thousand impressions for each of one or more banner types on each of the one or more networks, an effective cost per thousand impressions for each of the one or more banner types on each of the one or more publishers and an effective cost per thousand impressions for each of the one or more banner types on each of the one or more publisher categories.

In an embodiment of the present disclosure, the third set of parameters corresponds to one or more properties associated with each of the plurality of advertisement campaigns. The one or more properties associated with each of the plurality of advertisement campaigns includes at least one of a daily event goal, a time limit for each of the plurality of advertisement campaigns and a set priority.

In an embodiment of the present disclosure, the computer-implemented method further includes storing, with the processor, the first set of parameters, the second set of parameters and the third set of parameters.

In an embodiment of the present disclosure, the calculation is performed based on a generation of a request from the one or more publishers.

In an embodiment of the present disclosure, the rank calculation when the daily event goal is provided for each of the plurality of advertisement campaigns is based on multiplication of a pre-defined factor and a cumulative effective cost per thousand impressions. The pre-defined factor is based on a total number of events for each of the plurality of advertisement campaigns, a remaining number of events for each of the plurality of advertisement campaigns, total time for each of the plurality of advertisement campaigns and a remaining time for each of the plurality of advertisement campaigns.

In an embodiment of the present disclosure, the one or more advertisements are displayed based on the effective cost per thousand impressions in a decreasing order of the effective cost per thousand impressions.

In another aspect of the present disclosure, a computer-program product for facilitating optimized serving of one or more advertisements on one or more publishers is provided. The computer-program product includes a computer readable storage medium having a computer program stored thereon for performing the steps of fetching a first set of parameters associated with one or more advertisers, the one or more publishers and the one or more advertisements associated with the one or more advertisers; calculating a probabilistic effective cost per thousand impressions value for a second set of parameters based on the first set of parameters, ranking each of a plurality of advertisement campaigns associated with each of the one or more advertisers and serving the one or more advertisements to one or more users on the corresponding one or more publishers based on the ranking of each of the plurality of advertisement campaigns. The second set of parameters is associated with the one or more advertisers, the one or more publishers and the one or more advertisements associated with the one or more advertisers. The effective cost per thousand impressions is calculated for the one or more advertisements associated with the one or more advertisers. The rank is assigned based on the probabilistic effective cost per thousand impressions value and a third set of parameters associated with each of the plurality of advertisement campaigns. The ranking is performed for assigning a priority level to each of the plurality of advertisement campaigns. The priority is assigned based on weights. The served one or more advertisements corresponding to the one or more advertisers are associated with a corresponding one or more advertisements campaigns of the plurality of advertisement campaigns having a highest rank and priority. The one or more advertisements are served in real time.

In an embodiment of the present disclosure, the computer-program product further includes dynamically updating the first set of parameters, the second set of parameters, the third set of parameters and the rank of each of each of the plurality of advertisement campaigns. The updating is done in real time.

In an embodiment of the present disclosure, the first set of parameters includes at least one of a name of each of the one or more advertisers, an advertiser ID of each of the one or more advertisers, an advertiser category of each of the one or more advertisers, an advertiser campaign information for each of the one or more advertisers, an advertiser campaign ID for each of the one or more advertisers, a banner type, a banner ID for each of the one or more advertisements, a publisher ID for each of the one or more publishers, name of an operating system associated with a portable communication device accessed by a user of the one or more users, time of impression request by the one or more publishers, an operating system version of the portable communication device accessed by the user of the one or more users, a publisher category for each of the one or more publishers and a network ID. The advertiser category and the publisher category are determined by utilizing a binary identification.

In an embodiment of the present disclosure, the second set of parameters includes at least one of an effective cost per thousand impressions for each banner ID on each publisher of the one or more publishers, an effective cost per thousand impressions for each of the one or more advertisers on each of the one or more publishers, an effective cost per thousand impressions for each of the one or more advertisers on each of one or more publisher categories associated with each of the one or more publishers, an effective cost per thousand impressions for each of one or more advertiser categories associated with the one or more advertisers on each of the one or more publishers, an effective cost per thousand impressions for each of the one or more advertiser categories on each of the one or more publisher categories, an effective cost per thousand impressions for each of one or more banners IDs on each of the one or more publishers, an effective cost per thousand impressions for each of the one or more banner IDs on each of the one or more publisher categories, an effective cost per thousand impressions for each of the one or more advertisers on each of one or more networks, an effective cost per thousand impressions of each of the one or more banner IDs on each of the one or more networks, an effective cost per thousand impressions of each of the one or more advertiser categories on each of the one or more networks, an effective cost per thousand impressions for each of one or more banner types on each of the one or more networks, an effective cost per thousand impressions for each of the one or more banner types on each of the one or more publishers and an effective cost per thousand impressions for each of the one or more banner types on each of the one or more publisher categories.

In an embodiment of the present disclosure, the third set of parameters corresponds to one or more properties associated with each of the plurality of advertisement campaigns. The one or more properties associated with each of the plurality of advertisement campaigns includes at least one of a daily event goal, a time limit for each of the plurality of advertisement campaigns and a set priority.

In yet another aspect of the present disclosure, an advertisement serving optimization system for facilitating optimized serving of one or more advertisements on one or more publishers is provided. The advertisement serving optimization system includes a fetching module in a processor, the fetching module is configured for fetching a first set of parameters associated with one or more advertisers, the one or more publishers and the one or more advertisements associated with the one or more advertisers; a calculation engine in the processor, the calculation engine is configured to calculate a probabilistic effective cost per thousand impressions value for a second set of parameters based on the first set of parameters; a priority setting module in the processor, the priority setting module is configured for ranking each of a plurality of advertisement campaigns associated with a corresponding one or more advertisers and an advertisement serving module in the processor, the advertisement serving module is configured to serve the one or more advertisements to one or more users on the corresponding one or more publishers based on the ranking of each of the plurality of advertisement campaigns. The second set of parameters is associated with the one or more advertisers, the one or more publishers and the one or more advertisements associated with the one or more advertisers. The effective cost per thousand impressions is calculated for the one or more advertisements associated with the one or more advertisers. The rank is assigned based on the probabilistic effective cost per thousand impressions value and a third set of parameters associated with each of the plurality of advertisement campaigns. The ranking is performed for assigning a priority level to each of the plurality of advertisement campaigns. The priority is assigned based on weights. The served one or more advertisements corresponding to the one or more advertisers are associated with a corresponding one or more advertisement campaigns of the plurality of advertisement campaigns having a highest rank and priority. The one or more advertisements are served in real time.

In an embodiment of the present disclosure, the advertisement serving optimization system further includes an updation engine in the processor, the updation engine is configured to dynamically update the first set of parameters, the second set of parameters, the third set of parameters and the rank of each of each of the plurality of advertisement campaigns. The updating is done in real time.

In an embodiment of the present disclosure, the first set of parameters includes at least one of a name of each of the one or more advertisers, an advertiser ID of each of the one or more advertisers, an advertiser category of each of the one or more advertisers, an advertiser campaign information for each of the one or more advertisers, an advertiser campaign ID for each of the one or more advertisers, a banner type, a banner ID for each of the one or more advertisements, a publisher ID for each of the one or more publishers, name of an operating system associated with a portable communication device accessed by a user of the one or more users, time of impression request by the one or more publishers, an operating system version of the portable communication device accessed by the user of the one or more users, a publisher category for each of the one or more publishers and a network ID. The advertiser category and the publisher category are determined by utilizing a binary identification.

In an embodiment of the present disclosure, the second set of parameters includes at least one of an effective cost per thousand impressions for each banner ID on each publisher of the one or more publishers, an effective cost per thousand impressions for each of the one or more advertisers on each of the one or more publishers, an effective cost per thousand impressions for each of the one or more advertisers on each of one or more publisher categories associated with each of the one or more publishers, an effective cost per thousand impressions for each of one or more advertiser categories associated with the one or more advertisers on each of the one or more publishers, an effective cost per thousand impressions for each of the one or more advertiser categories on each of the one or more publisher categories, an effective cost per thousand impressions for each of one or more banners IDs on each of the one or more publishers, an effective cost per thousand impressions for each of the one or more banner IDs on each of the one or more publisher categories, an effective cost per thousand impressions for each of the one or more advertisers on each of one or more networks, an effective cost per thousand impressions of each of the one or more banner IDs on each of the one or more networks, an effective cost per thousand impressions of each of the one or more advertiser categories on each of the one or more networks, an effective cost per thousand impressions for each of one or more banner types on each of the one or more networks, an effective cost per thousand impressions for each of the one or more banner types on each of the one or more publishers and an effective cost per thousand impressions for each of the one or more banner types on each of the one or more publisher categories.

In an embodiment of the present disclosure, the third set of parameters corresponds to one or more properties associated with each of the plurality of advertisement campaigns. The one or more properties associated with each of the plurality of advertisement campaigns includes at least one of a daily event goal for each of the plurality of advertisement campaigns, a time limit for each of the plurality of advertisement campaigns and a set priority.

In an embodiment of the present disclosure, the advertisement serving optimization system further includes a database in the processor; the database is configured to store the first set of parameters, the second set of parameters and the third set of parameters.

### BRIEF DESCRIPTION OF THE FIGURES

Having thus described the invention in general terms, reference will now be made to the accompanying drawings, which are not necessarily drawn to scale, and wherein:

FIG. 1A and FIG. 1B illustrates a general overview of a system for facilitating optimized serving of one or more advertisements, in accordance with various embodiments of the present disclosure; and

FIG. 2 illustrates a block diagram of a communication device, in accordance with various embodiments of the present disclosure; and

FIG. 3 illustrated a flowchart for facilitating the optimized serving of the one or more advertisements, in accordance with various embodiments of the present disclosure.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

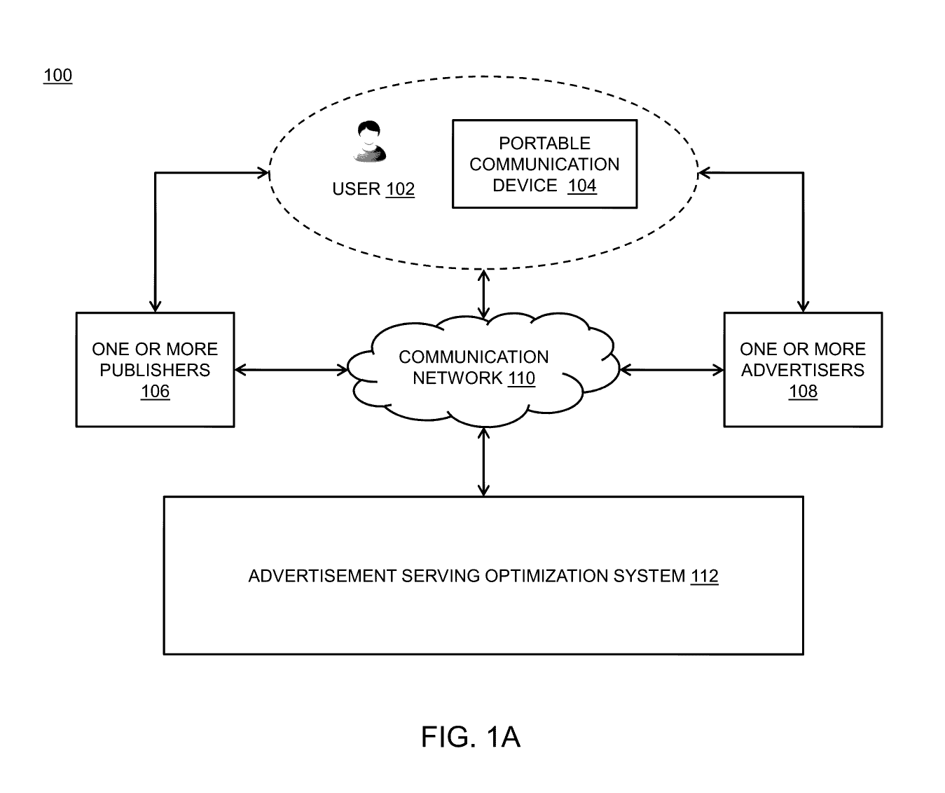

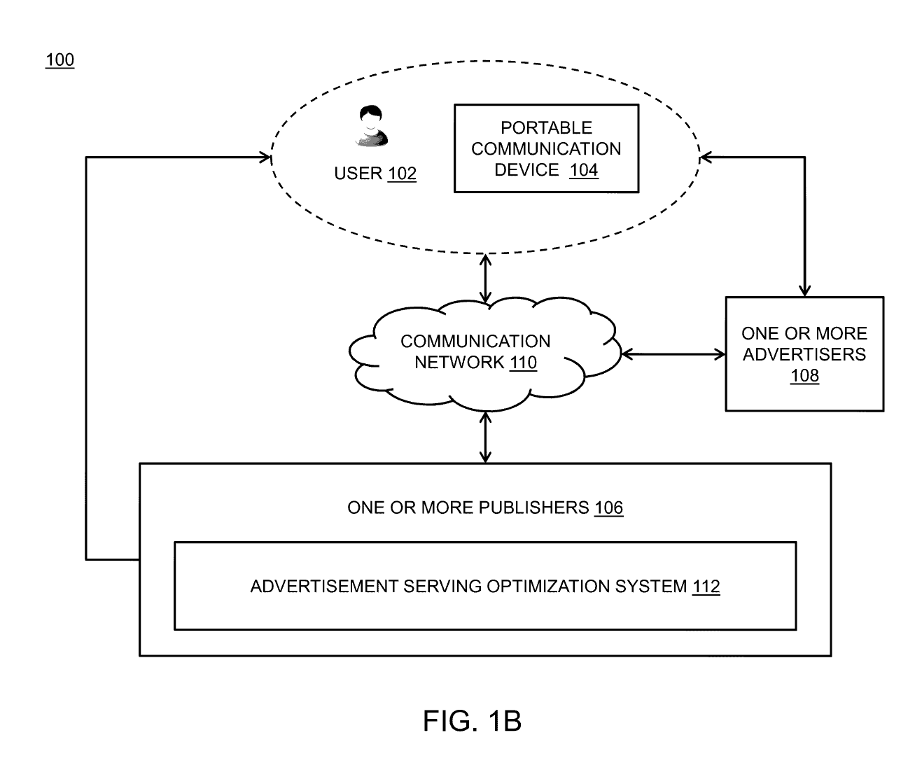

FIG. 1A illustrates a general overview of a system 100 for facilitating optimized serving of one or more advertisements on one or more publishers accessed by one or more users, in accordance with various embodiments of the present disclosure. The system 100 includes a portable communication device 104 associated with a user 102, one or more publishers 106, one or more advertisers 108, a communication network 110 and an advertisement serving optimization system 112. In addition, the advertisement serving optimization system 112 enables the optimizing the serving of the one or more advertisements on the one or more publishers 106 accessed by the user 102 of the one or more users in real time.

Going further, the system 100 enables the one or more publishers 106 to increase performance of the one or more advertisements and generate higher revenue by providing or serving the one or more advertisements which are relevant to the user 102 of the one or more users (as explained below in the patent application). In addition, the user 102 may be any person or individual currently accessing the portable communication device 104. In an embodiment of the present disclosure, the user 102 is an owner of the portable communication device 104. Examples of the portable communication device 104 include but may not be limited to a smart phone, a desktop computer, a laptop, a tablet, a personal digital assistant, a wearable device or any other portable communication device known in the art. In addition, the portable communication device 104 is associated with a specific type of operating system. The type of operating system associated with the portable communication device 104 includes but may not be limited to an Android operating system, iOS, Mac operating system, Windows operating system, Bada operating system and Symbian operating system.

Moreover, the portable communication device 104 includes an internet facility. In an embodiment of the present disclosure, the portable communication device 104 is presently connected to the internet. In an embodiment of the present disclosure, the portable communication device 104 is connected to the internet through a WiFi connection. In another embodiment of the present disclosure, the portable communication device 104 is connected to the internet through a data connection provided by a telecom service provider. In an embodiment of the present disclosure, the portable communication device 104 is connected to an internet broadband system, a local area network, a wide area network, a digital or analog cable television network or any other communication network presently known in the art. The internet broadband system maybe a wired or a wireless system.

In an embodiment of the present disclosure, the user 102 accesses the portable communication device 104 for accessing a browser of one or more browsers for accessing the one or more publishers 106. In an embodiment of the present disclosure, the user 102 accesses one or more websites of the corresponding one or more publishers 106 for accessing any content. In an embodiment of the present disclosure, the website accessed by the user 102 on the portable communication device 104 may show content related to interests of the user 102. For example, the user 102 may be interested in watching online videos, reading blogs, play online games, accessing social networking sites and the like

Further, the one or more publishers 106 correspond to one or more website owners for providing content to the one or more users. Furthermore, the one or more publishers 106 provide the one or more users with a single type of content or a multiple type of content. The type of content includes one or more video content, one or more audio content, one or more text content, one or more audio-video content and the like. Moreover, each of the one or more publishers 106 is associated with a specific category of publishers. In addition, the specific category of publishers include an e-commerce category, a games category, a social networking category, a news category, a real estate category or any other category of publishers known in the art. Examples of the one or more publishers 106 include but may not be limited to facebook, YouTube, Amazon, jabong, myntra, fashionandyou, dailymotion, flipkart, snapdeal and twitter.

Going further, the one or more publishers 106 provide space, areas or a part of their web pages for advertising purposes. These areas or spaces on the web pages are referred to as advertisement slots. The web page can have the various advertisement slots depending on choice of each of the one or more publishers 106. The one or more publishers 106 advertise products, services or businesses to the one or more users for generating revenue. It may be noted that the term publisher in context of the present application may be referred to as publisher website which may have advertisement slots for advertising. In an embodiment of the present disclosure, the term publisher in context of the present application may be referred to as a mobile application or a mobile website which may have the advertisement slots for advertising.

In an embodiment of the present disclosure, the one or more publishers 106 display the one or more advertisements on the corresponding advertisement slots in the web pages of the one or more publishers 106. In an embodiment of the present disclosure, the one or more publishers 106 display the one or more advertisements when the user 102 requests for the content to be displayed on the one or more publishers 106 website. In an embodiment of the present disclosure, the one or more advertisements are displayed for generating revenue based on number of impressions, number of clicks, number of installs or other one or more actions taken by the one or more users on viewing or encountering the one or more advertisements.

In an embodiment of the present disclosure, the one or more advertisements are displayed during viewing of the content. For example, a user A encounter an advertisement while watching a video on a publisher (say, Youtube). In another embodiment of the present disclosure, the one or more advertisements are displayed along with the content viewed by the user 102 of the one or more users in the corresponding one or more advertisement slots on the one or more publishers 106. Moreover, the one or more publishers 106 are associated with the one or more advertisers 108. In addition, the one or more advertisers 108 provide advertisements to the one or more publishers 106 for displaying on their website or application. The advertisements are placed on the advertisement slots on the website or the application.

Further, the one or more advertisers 108 purchase the one or more advertisement slots from the one or more publishers 106. In an embodiment of the present disclosure, the one or more advertisers 108 purchase the advertisement slots for displaying the one or more advertisements on the corresponding advertisement slots for generating revenue based on the number of impressions, the number of clicks, the number of installs or other one or more actions taken by the one or more users on viewing the corresponding one or more advertisements on the one or more publishers 106. Moreover, the one or more advertisers 108 provide the one or more advertisements to the one or more publishers 106 in real time.

In an embodiment of the present disclosure, the one or more advertisements displayed are associated with the interests of the user 102. In an embodiment of the present disclosure, the one or more advertisements correspond to a content viewing history of the one or more users for attracting more number of clicks from the one or more users in order to increase the revenue generation. Going further, the one or more advertisers 108 and the one or more publishers 104 are associated through one or more advertisement supplying intermediaries. In addition, the advertisement supplying intermediaries include advertisement exchanges, advertisement networks, affiliates, advertisement agencies, and the like.

Moreover, the advertisement supplying intermediaries enables a connection or link between the one or more publishers 106 and the one or more advertisers 108. In an embodiment of the present disclosure, the advertisement supplying intermediaries works as a third party medium for efficient buying and selling of the one or more advertisement slots. In an embodiment of the present disclosure, the advertisement supplying intermediaries is a platform for buying and selling of advertisement inventory between the one or more publishers 106 and the one or more advertisers 108. In an embodiment of the present disclosure, the advertisement supplying intermediaries deal with the one or more publishers 106 and the one or more advertisers 108 through a mutual contract for defining terms and conditions associated with revenue.

Moreover, the one or more advertisers 108 define a plurality of advertisement campaigns for marketing their products on the one or more publishers 106 online through the one or more advertisements. Further, each of the plurality of advertisement campaigns defines a series of campaign goals in order to achieve the desired result and increase revenue. The campaign goals are defined by the one or more advertisers 108 based on their category of products and a specific segment of the one or more users that the one or more advertisers 108 wish to target in order to maximize their profit. In an embodiment of the present disclosure, the advertisement supplying intermediaries run the plurality of advertisement campaigns on behalf of the one or more advertisers 108.

In an embodiment of the present disclosure, the advertisement supplying intermediaries monitor the plurality of advertisement campaigns and performance of each of the plurality of advertisement campaigns of the each of the corresponding one or more advertisers 108. In an embodiment of the present disclosure, the plurality of advertisement campaigns defines a time limit for running each of a campaign provided by the one or more advertisers 108. In addition, the one or more publishers 106 and the one or more advertisers 108 earn revenue based on a compensation method. In an embodiment of the present disclosure, the compensation method corresponds to an effective cost per thousand impressions. In addition, the effective cost per thousand impressions (eCPM) is calculated by dividing a total revenue generated for a particular campaigns and the total number of impressions as known in the art.

In an embodiment of the present disclosure, the effective cost per thousand impressions is utilized for determining the performance of each of the plurality of advertisement campaigns (as explained below in the patent application). In an embodiment of the present disclosure, the one or more publishers 106 have a mutual agreement with the one or more advertisers 108 for sharing the revenue based on the effective cost per thousand impressions.

Going further, the portable communication device 104 is associated with the communication network 110. In an embodiment of the present disclosure, the portable communication device 104 is associated with the one or more publishers 106 and the one or more advertisers 108 through the communication network 110. In an embodiment of the present disclosure, the one or more publishers 106 are associated with the one or more advertisers 108 through the communication network 110. In an embodiment of the present disclosure, the advertisement supplying intermediaries is associated with the one or more publishers 106 and the one or more advertisers 108 through the communication network 110.

In addition, the communication network 110 enables the portable communication device 104 to connect to the internet. In an embodiment of the present disclosure, the user 102 accesses the one or more publishers 106 on the corresponding portable communication device 104 through the communication network 110. Further, the medium for communication may be infrared, microwave, radio frequency (RF) and the like. The communication network 110 include but may not be limited to a local area network, a metropolitan area network, a wide area network, a virtual private network, a global area network, a home area network or any other communication network presently known in the art. The communication network 110 is a structure of various nodes or communication devices connected to each other through a network topology method. Examples of the network topology include a bus topology, a star topology, a mesh topology and the like.

Going further, the one or more publishers 106 and the one or more advertisers 108 are associated with the advertisement serving optimization system 112. In an embodiment of the present disclosure, the one or more publishers 106 and the one or more advertisers 108 are associated with the advertisement serving optimization system 112 through the communication network 110. Moreover, the advertisement serving optimization system 112 performs the optimizing of the serving of the one or more advertisements to the one or more users on the corresponding one or more publishers 106. In an embodiment of the present disclosure, the advertisement serving optimization system 112 is a part of the advertisement supplying intermediaries for optimizing the serving of the one or more advertisements.

Further, the advertisement serving optimization system 112 is configured for fetching a first set of parameters associated with the one or more publishers 106 and the one or more advertisers 108. Furthermore, the advertisement serving optimization system 112 performs one or more operations on the first set of parameters (as described below in the patent application). Moreover, the advertisement serving optimization system 112 is configured to assign a priority level to each of the plurality of advertisement campaigns associated with each of the one or more advertisers 108 by performing one or more operations (as described below in the patent application).

In addition, the advertisement serving optimization system 112 is configured to calculate the effective cost per thousand impressions for a second set of parameters (as described below in the patent application). Further, the advertisement serving optimization system 112 is configured to serve the one or more advertisements to the one or more users based on a pre-defined criterion (as mentioned below in the patent application). In an embodiment of the present disclosure, the one or more advertisements are displayed on the corresponding one or more advertisement slots on the corresponding one or more publishers 106.

It may be noted that in FIG. 1A, the user 102 is associated with the portable communication device 104; however those skilled in the art would appreciate that there are more number of users associated with more number of portable communication devices. For example, a user X, a user Y and a user Z are associated with a communication device D1, a communication device D2 and a communication device D3. It may also be noted that in FIG. 1A, the user 102 accesses the one or more publishers 106 on the corresponding portable communication device 104; however those skilled in the art would appreciate that there more number users accessing the one or more publishers 106 on more number of portable communication devices.

In an embodiment of the present disclosure, as illustrated in FIG. 1B, the advertisement serving optimization system 112 is part of the one or more publishers 106. In an embodiment of the present disclosure, the one or more publishers 106 include the advertisement serving optimization system 112. In an embodiment of the present disclosure, the advertisement serving optimization system 112 is located on a backend of each of the one or more publishers 106. In an embodiment of the present disclosure, the one or more publishers 106 are registered on the advertisement serving optimization system 112. In another embodiment of the present disclosure, the one or more publishers 106 have an account on the advertisement serving optimization system 112. In an embodiment of the present disclosure, the advertisement serving optimization system 112 provides a web-based interface for the one or more publishers 106.

Going further, in an embodiment of the present disclosure, the one or more publishers 106 register on the advertisement serving optimization system 112 by paying some pre-defined amount of money in order to avail one or more services offered by the advertisement serving optimization system 112. In an embodiment of the present disclosure, the advertisement serving optimization system 112 may accept multiple forms of payment to fund the account, such as electronic transfer (e.g., automated clearing house (ACH) transfer or wire transfer) from a designated bank account, credit card (e.g., Visa, MasterCard, Discover, American Express), online wallet (e.g., PayPal, Amazon Payments and Google Checkout) and/or mobile payment.

In an embodiment of the present disclosure, the advertisement serving optimization system 112 enables the one or more publishers 106 to download one or more comprehensive reports associated with the performance of the one or more advertisements associated with the one or more advertisers 108.

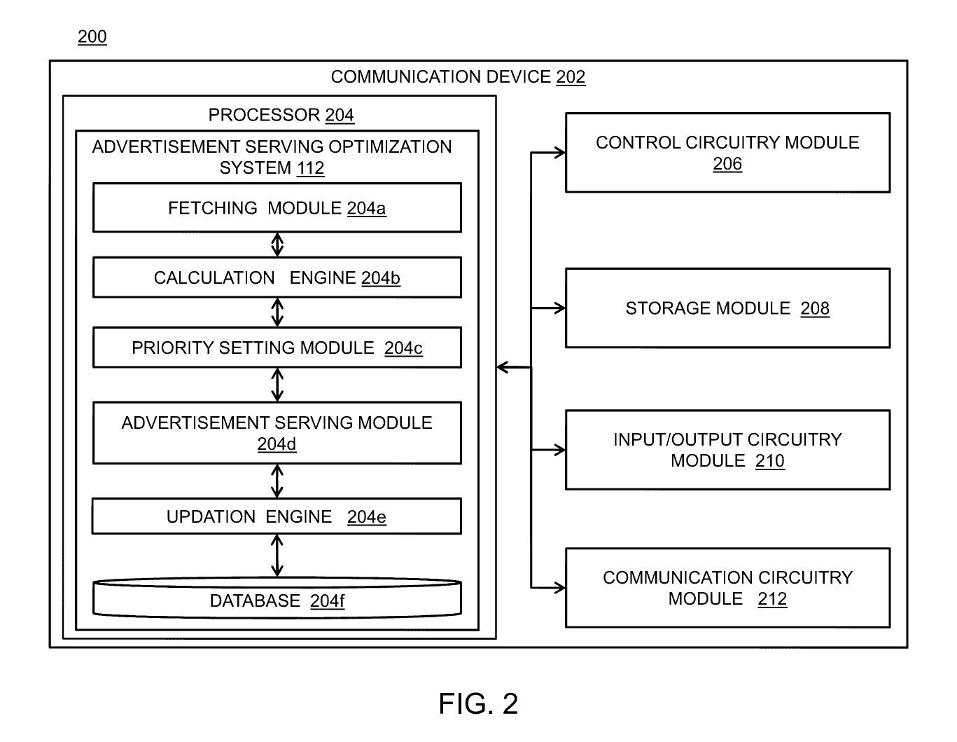

FIG. 2 illustrates a block diagram 200 of a communication device 202, in accordance with various embodiments of the present disclosure. The communication device 202 includes a processor 204, a control circuitry module 206, a storage module 208, an input/output circuitry module 210 and a communication circuitry module 212. In an embodiment of the present disclosure, the processor 204 includes one or more components of the advertisement serving optimization system 112. Further, the one or more components of the advertisement serving optimization system 112 in the processer 204 includes a fetching module 204a, a calculation module 204b, a priority setting module 204c, an advertisement serving module 204d, an updation engine 204e and a database 204f.

It may be noted that to explain the system elements of FIG. 2, references will be made to the system elements of FIG. 1A and FIG. 1B. In an embodiment of the present disclosure, the processor 204 enables the working of the advertisement serving optimization system 112 for the optimizing of the serving of the one or more advertisements to the one or more users on the corresponding one or more publishers 106. In an embodiment of the present disclosure, the one or more components of the advertisement serving optimization system 112 enables the optimizing of the serving of the one or more advertisements on the one or more publishers 106. In an embodiment of the present of the disclosure, the communication device 202 enables the hosting of the advertisement serving optimization system 112.

Going further, the fetching module 204a in the processor 204 is configured for fetching the first set of parameters. In addition, the first set of parameters is associated with the one or more advertisers 108, the one or more publishers 106 and the one or more advertisements associated with the one or more advertisers 106. In an embodiment of the present disclosure, the fetching module 204a fetches the first set of parameters from a server associated with the one or more publishers 106 and the one or more advertisers 108. In an embodiment of the present disclosure, the advertisement serving optimization system 112 is linked with the server of each of the one or more publishers 106 and each of the one or more advertisers 108 for fetching the first set of parameters.

Further, the first set of parameters corresponds to one or more publisher properties and one or more advertiser properties. In an embodiment of the present disclosure, the first set of parameters contains one or more properties associated with each of the plurality of advertisement campaigns of the one or more advertisers 108. In an embodiment of the present disclosure, the first set of parameters correspond to information associated with the user 102 and the portable communication device 104 fetched in real time when the user 102 accesses the one or more publishers 106. In an embodiment of the present disclosure, the first set of parameters is pre-stored in a database of the advertisement supplying intermediaries. In an embodiment of the present disclosure, the first set of parameters is pre-stored in the advertisement serving optimization system 112.

Furthermore, the first set of parameters include but may not be limited to a name of each of the one or more advertisers 108, an advertiser ID of each of the one or more advertisers 108, an advertiser category of each of the one or more advertisers 108, an advertiser campaign information for each of the one or more advertisers 108, an advertiser campaign ID for each of the one or more advertisers 108, a banner type, a banner ID for each of the one or more advertisements, a publisher ID for each of the one or more publishers 106, name of an operating system associated with the portable communication device 104 accessed by the user 102 of the one or more users, time of impression request by the one or more publishers 106, an OS version of the portable communication device 104 accessed by the user 102 of the one or more users, a publisher category for each of the one or more publishers 106 and a network ID.

In addition, the advertiser category corresponds to a class of products or services associated with the one or more advertisers 108. In an embodiment of the present disclosure, the advertiser category corresponds to a type of the products, services and the like illustrated through the one or more advertisements. Moreover, the publisher category corresponds to a specific class of website or application associated with each of the one or more publishers 106. The publisher category includes real estate category, games category, e-commerce category or any other class of websites which are capable of displaying the one or more advertisements to the one or more users.

In an embodiment of the present disclosure, the advertiser category and the publisher category is determined by utilizing binary identification. In an embodiment of the present disclosure, each publisher is recognized through a binary code. The binary code is pre-stored in the advertisement serving optimization system 112. In an embodiment of the present disclosure, a fixed number of binary codes are stored in the advertisement serving optimization system 112 based on number of the one or more publishers 106 and the one or more advertisers 108 are linked with the advertisement serving optimization system 112. In an embodiment of the present disclosure, the binary identification is done when the user 102 accesses the one or more publishers 106 and the one or more advertisers 108 are trying to display the one or more advertisements on the one or more publishers 106.

In an embodiment of the present disclosure, the operating system and the operating system version of the portable communication device 104 is determined by extracting a device ID of the portable communication device 104 when the user 104 accesses the one or more publishers 106 through the corresponding portable communication device 104. In an embodiment of the present disclosure, the network ID corresponds to an ID of an advertisement network managing the optimization of the serving of the one or more advertisements for the one or more publishers 106 and the one or more advertisers 108. Moreover, the advertisement campaign information corresponds to information associated with one or more campaign goals associated with each of the plurality of advertisement campaigns.

Moreover, the calculation module 204b in the processor 204 is configured to calculate a probabilistic effective cost per thousand impressions value for the second set of parameters based on the first set of parameters. In addition, the second set of parameters is associated with the one or more advertisers 108, the one or more publishers 106 and the one or more advertisements associated with the one or more advertisers 108. The effective cost per thousand impressions is calculated for the one or more advertisements associated with the one or more advertisers 108.

In an embodiment of the present disclosure, the calculation module 204b monitors the performance of each of the one or more advertisements on the corresponding one or more publishers 106 by calculating the effective cost per thousand impressions on a pre-defined intervals of time. In an embodiment of the present disclosure, the effective cost per thousand impressions is calculated for a number of combinations of the one or more advertisers 108 and the one or more publishers 106. In an embodiment of the present disclosure, the effective cost per thousand impressions is calculated for determining performance of each of the one or more advertisements on each of the one or more publishers 106. In an embodiment of the present disclosure, the effective cost per thousand impressions is calculated in real time.

Moreover, the second set of parameters corresponds to a plurality of combinations of the one or more publishers 106 and the one or more advertisers 108. Further, the second set of parameters include but may not be limited to an effective cost per thousand impressions for each banner ID on each publisher of the one or more publishers 106, an effective cost per thousand impressions for each of the one or more advertisers 108 on each of the one or more publishers 106, an effective cost per thousand impressions for each of the one or more advertisers 108 on each of one or more publisher categories associated with each of the one or more publishers 106, an effective cost per thousand impressions for each of one or more advertiser categories associated with the one or more advertisers 108 on each of the one or more publishers 106, an effective cost per thousand impressions for each of the one or more advertiser categories on each of the one or more publisher categories, an effective cost per thousand impressions for each of one or more banners IDs on each of the one or more publishers 106, an effective cost per thousand impressions for each of the one or more banner IDs on each of the one or more publisher categories, an effective cost per thousand impressions for each of the one or more advertisers 108 on each of one or more networks, an effective cost per thousand impressions of each of the one or more banner IDs on each of the one or more networks, an effective cost per thousand impressions of each of the one or more advertiser categories on each of the one or more networks, an effective cost per thousand impressions for each of one or more banner types on each of the one or more networks, an effective cost per thousand impressions for each of the one or more banner types on each of the one or more publishers 106 and an effective cost per thousand impressions for each of the one or more banner types on each of the one or more publisher categories.

In an embodiment of the present disclosure, the calculation module 204b calculates the effective cost per thousand impressions for each of the above stated second set of parameters. In an embodiment of the present disclosure, the calculation module 204b also calculates the number of impressions, the number of clicks and the number of installs corresponding to each of the one or more advertisements. In an embodiment of the present disclosure, the calculation module 204b calculates the second set of parameters after collecting information about each of the one or more publishers 106, the one or more advertisers 108 and the one or more advertisements.

In an embodiment of the present disclosure, the second set of parameters is divided into independent parameters and dependent parameters. The dependent parameter corresponds to the effective cost per thousand impressions for each banner ID on each of the one or more publishers 106. In an embodiment of the present disclosure, the remaining parameters correspond to the independent parameters.

For example, a user A visits a publisher P through a portable communication device D (say, laptop). The publisher P displays a banner advertisement B on an advertisement slot S on the publisher P. Moreover, the publisher P is an e-commerce category publisher. In addition, the banner advertisement B has a banner id (say, 001) and an advertiser associated with the banner advertisement B has an advertiser ID (say, 01). The calculation module 204b calculates total number of impressions, total number of clicks, total number of installs and total revenue generated of the banner advertisement B with the banner ID (001) on all the e-commerce publishers. Further, the calculation module 204b calculates the effective cost per thousand impressions for the banner ID (001) on all the e-commerce publishers based on the standard formula.

In an embodiment of the present disclosure, the calculation module 204b calculates the effective cost per thousand impressions for category sub-parameters. The category sub-parameters correspond to category of the one or more publishers 106. In an embodiment of the present disclosure, the effective cost per thousand impressions is calculated based on a regression equation which predicts the effective cost per thousand impressions on basis of the first set of parameters and the second set of parameters. The regression equation is given by

Y=Beta0+(Beta i*parameter i) for i=1 to n

In the above regression equation, Y denotes the probabilistic effective cost per thousand impressions, Beta corresponds to weights and parameter corresponds to the first set of parameters and the second set of parameters. In an embodiment of the present disclosure, the Beta can be in decimal and negative numbers. For example, the regression equation calculates the effective cost per thousand impression for an advertiser a1 on a publisher p1 with some banner type t1 and banner id b1 on a network n1.

Further, in an embodiment of the present disclosure, the calculation is performed based on a generation of a request from the one or more publishers 106. In an embodiment of the present disclosure, the one or more publishers 106 request the one or more advertisement for displaying to the user 102. In an embodiment of the present disclosure, the identification of the banner type is performed using the binary identification when the banner ad request is made. Moreover, the banner type includes interstitial, banner, dialog, expandable and app icon. For example, a publisher P requests the advertisement from an ad server. The banner type includes a banner b1 (interstitial), a banner b2 (banner), a banner b3 (dialog), a banner b4 (expandable) and a banner b5 (app icon). The request is made for a banner ad which is displayed on the publisher P website. According to the regression equation, b2 is equal to 1 and b1, b3, b4 and b5 are zero. Therefore, the calculation module 204b identifies the advertisement as banner ad according to the binary code and assigns weigh to correct parameter.

In an embodiment of the present disclosure, the advertiser category is computed in the same way as above for calculating the effective cost per thousand impressions. Similarly, the calculation module 204b calculated the effective cost per thousand impressions for rest of the second set of parameters for monitoring the performance of the one or more advertisements in real time.

Going further, the priority setting module 204c in the processor 204 is configured for ranking each of the plurality of advertisement campaigns associated with each of the one or more advertisers 108. The rank is assigned based on the probabilistic effective cost per thousand impressions value and a third set of parameters associated with each of the plurality of advertisement campaigns. In addition, the ranking is performed for assigning a priority level to each of the plurality of advertisement campaigns. Moreover, the priority is assigned based on weights. In an embodiment of the present disclosure, the priority setting module 204c gives higher priority to one or more advertisement campaigns of the plurality of advertisement campaigns based on their performance.

Further, the third set of parameters corresponds to one or more properties associated with each of the plurality of advertisement campaigns. The one or more properties associated with each of the plurality of advertisement campaigns include a daily event goal, a time limit for each of the plurality of advertisement campaigns and a set priority. In addition, the third set of parameters is defined by each of the one or more advertisers 108 for their corresponding advertisement campaigns. In an embodiment of the present disclosure, the one or more advertisers may or may not define the third set of parameters.

In an embodiment of the present disclosure, the ranking is done for allowing advertisement campaigns of the plurality of advertisement campaigns having a better effective cost per thousand impressions value to be given a higher preference for displaying targeted advertisements to the one or more users. Further, the ranking allows the advertisement supplying intermediaries to generate more revenue by displaying the one or more advertisements of the one or more advertisers 108 having a higher effective cost per thousand impressions which in turn benefits the advertisement supplying intermediaries. In an embodiment of the present disclosure, the priority setting module 204c assigns more weight to the advertisement campaigns with higher effective cost per thousand impressions by taking in account the campaigns goals of the one or more advertisers 104 in order to allow the one or more advertisers 108 achieve their target in the defined time limit.

In an embodiment of the present disclosure, the rank calculation when the daily event goal is provided for each of the plurality of advertisement campaigns is based on multiplication of a pre-defined factor and a cumulative effective cost per thousand impressions. Moreover, the pre-defined factor is based on a total number of events for each of the plurality of advertisement campaigns, a remaining number of events for each of the plurality of advertisement campaigns, total time for each of the plurality of advertisement campaigns and a remaining time for each of the plurality of advertisement campaigns. In an embodiment of the present disclosure, the rank is calculated using the formula given below

D=(Re/Te)/(Tt /Rt)

Rank=D*y

In the above formula, D corresponds to the pre-defined factor, Re corresponds to remaining number of events, Te corresponds to total number of events, Tt corresponds to total number of time and Rt corresponds to remaining number of events. Moreover, the rank is calculated by multiplying the pre-defined factor (D) and the predicted effective cost per thousand impressions (y).

In an embodiment of the present disclosure, the daily event goal is dynamically calculated when the one or more advertisers 108 do not provide the daily event goal based on a predictive batch processing method. In an embodiment of the present disclosure, a data associated with the one or more advertisements is fetched for a pre-defined interval of time and the daily event goal is then calculated based on the data. In an embodiment of the present disclosure, the priority is assigned based on a pre-determined criterion when the data is not available for the pre-defined interval of time. In an embodiment, the pre-determined criterion corresponds to a pre-defined goal associated with the number of impressions given to the one or more advertisements. For example, a banner is provided a goal of 30,000 impressions and if the banner reaches 80% goal at end of the pre-defined interval (say, 7 days), then the goal is increased by 20%. In another case, when the banner reaches 40% goal, then the goal is decreased by 20%. In this way, the priority setting module 204c gives more weight to banners which are performing well as compared to banners which are not based on the effective cost per thousand impressions.

Going further, the advertisement serving module 204d in the processor 204 is configured to serve the one or more advertisements to the one or more users on the corresponding one or more publishers 106 based on the ranking of each of the plurality of advertisement campaigns. The served one or more advertisements corresponding to the one or more advertisers 108 associated with a corresponding one or more advertisements campaigns of the plurality of advertisement campaigns having the highest rank and priority. In addition, the one or more advertisements are served in real time.

In an embodiment of the present disclosure, the one or more advertisements are served in a decreasing order of the effective cost per thousand impressions. In an embodiment of the present disclosure, the advertisement serving module 204d allows serving of the one or more advertisements having higher effective cost per thousand impressions taking into account the daily event goals of the one or more advertisers 108. In an embodiment of the present disclosure, the one or more advertisements are displayed in the corresponding advertisement slots of the corresponding one or more publishers 106. In an embodiment of the present disclosure, the one or more advertisements are served on a specific category of publishers on which the one or more advertisers 108 have the highest effective cost per thousand impressions.

In an embodiment of the present disclosure, the one or more advertisements are served for the one or more advertisers 108 belonging to a specific category of advertisers having the highest effective cost per thousand impressions on the specific category of the one or more publishers 106. In an embodiment of the present disclosure, the one or more advertisements is served in one or more formats including audio format, rich media format, video format, multi-media format and the like. In an embodiment of the present disclosure, the one or more advertisements are displayed in a sorted list. In an embodiment of the present disclosure, the one or more advertisements are served based on the operating system of the portable communication device 104.

Moreover, the updation engine 204e in the processor 204 is configured to dynamically update the first set of parameters, the second set of parameters, the third set of parameters and the rank of each of each of the plurality of advertisement campaigns. In addition, the updating is done in real time. In an embodiment of the present disclosure, the updating is done for machine based learning and refining the optimization algorithm. Further, the database 204f in the processor 204 is configured to store the first set of parameters, the second set of parameters and the third set of parameters.

It may be noted that in FIG. 2, various modules of the advertisement serving optimization system 112 are shown that illustrates the working of the advertisement serving optimization system 112; however those skilled in the art would appreciate that the advertisement serving optimization system 112 may have more number of modules that could illustrate overall functioning of the advertisement serving optimization system 112.

Going further, the communication device 202 includes any suitable type of portable electronic device. Examples of the communication device 202 include but may not be limited to a personal e-mail device (e.g., a Blackberry™ made available by Research in Motion of Waterloo, Ontario), a personal data assistant (“PDA”), a cellular telephone, a Smartphone, the laptop computer, and the tablet computer. In another embodiment of the present disclosure, the communication device 202 can be a desktop computer.

From the perspective of this disclosure, the control circuitry module 206 includes any processing circuitry or processor operative to control the operations and performance of the communication device 202. For example, the control circuitry module 206 may be used to run operating system applications, firmware applications, media playback applications, media editing applications, or any other application. In an embodiment, the control circuitry module 206 drives a display and process inputs received from the user interface. From the perspective of this disclosure, the storage module 208 includes one or more storage mediums including a hard-drive, solid state drive, flash memory, permanent memory such as ROM, any other suitable type of storage component, or any combination thereof. The storage module 208 may store, for example, media data (e.g., music and video files), application data (e.g., for implementing functions on the communication device 202).

From the perspective of this disclosure, the I/O circuitry module 210 may be operative to convert (and encode/decode, if necessary) analog signals and other signals into digital data. In an embodiment, the I/O circuitry module 210 may also convert the digital data into any other type of signal and vice-versa. For example, the I/O circuitry module 210 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 206, the storage module 208 or any other component of the communication device 202. It may be noted that the I/O circuitry module 210 is illustrated in FIG. 2 as a single component of the communication device 202; however those skilled in the art would appreciate that several instances of the I/O circuitry module 210 may be included in the communication device 202.

The communication device 202 may include any suitable interface or component for allowing the user 102 to provide inputs to the I/O circuitry module 210. The communication device 202 may include any suitable input mechanism. Examples of the input mechanism include but may not be limited to a button, keypad, dial, a click wheel, and a touch screen. In an embodiment, the communication device 202 may include a capacitive sensing mechanism, or a multi-touch capacitive sensing mechanism. In an embodiment, the communication device 202 may include specialized output circuitry associated with output devices such as, for example, one or more audio outputs. The audio output may include one or more speakers built into the communication device 202, or an audio component that may be remotely coupled to the communication device 202.

The one or more speakers can be mono speakers, stereo speakers, or a combination of both. The audio component can be a headset, headphones or ear buds that may be coupled to the communication device 202 with a wire or wirelessly. In an embodiment, the I/O circuitry module 210 may include display circuitry for providing a display visible to the user 102. For example, the display circuitry may include a screen (e.g., an LCD screen) that is incorporated in the communication device 202. The display circuitry may include a movable display or a projecting system for providing a display of content on a surface remote from the communication device 202 (e.g., a video projector). In an embodiment, the display circuitry may include a coder/decoder to convert digital media data into the analog signals. For example, the display circuitry may include video Codecs, audio Codecs, or any other suitable type of Codec.

The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 206. Alternatively, the display circuitry may be operative to provide instructions to a remote display. In addition, the communication device 202 includes the communication circuitry module 212. The communication circuitry module 212 may include any suitable communication circuitry operative to connect to a communication network and to transmit communications (e.g., voice or data) from the communication device 202 to other devices within the communications network. The communication circuitry module 212 may be operative to interface with the communication network using any suitable communication protocol. Examples of the communication protocol include but may not be limited to Wi-Fi, Bluetooth®, radio frequency systems, infrared, LTE, GSM, GSM plus EDGE, CDMA, and quadband.

In an embodiment, the communication circuitry module 212 may be operative to create a communications network using any suitable communications protocol. For example, the communication circuitry module 212 may create a short-range communication network using a short-range communications protocol to connect to other devices. For example, the communication circuitry module 212 may be operative to create a local communication network using the Bluetooth® protocol to couple the communication device 202 with a Bluetooth® headset.

It may be noted that the computing device is shown to have only one communication operation; however, those skilled in the art would appreciate that the communication device 202 may include one more instances of the communication circuitry module 212 for simultaneously performing several communication operations using different communication networks. For example, the communication device 202 may include a first instance of the communication circuitry module 212 for communicating over a cellular network, and a second instance of the communication circuitry module 212 for communicating over Wi-Fi or using Bluetooth®. In an embodiment of the present disclosure, the same instance of the communication circuitry module 212 may be operative to provide for communications over several communication networks. In an embodiment, the communication device 202 may be coupled to a host device for data transfers, syncing the communication device 202, software or firmware updates, providing performance information to a remote source (e.g., providing riding characteristics to a remote server) or performing any other suitable operation that may require the communication device 202 to be coupled to the host device. Several computing devices may be coupled to a single host device using the host device as a server. Alternatively or additionally, the communication device 202 may be coupled to the several host devices (e.g., for each of the plurality of the host devices to serve as a backup for data stored in the communication device 202).

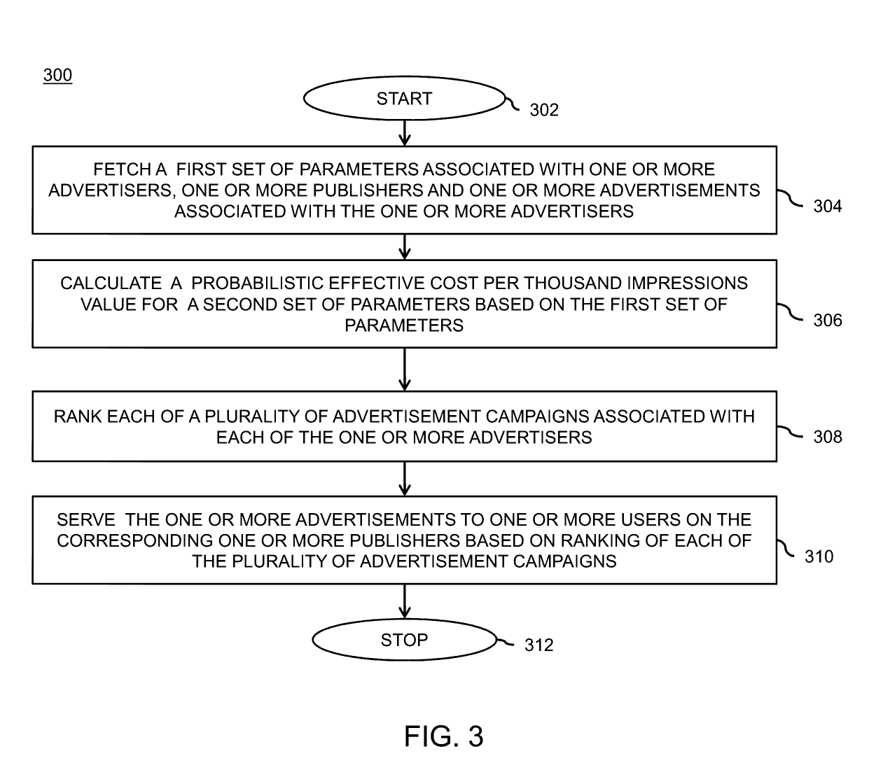

FIG. 3 illustrates a flowchart 300 for facilitating the optimized serving of the one or more advertisements, in accordance with various embodiments of the present disclosure. It may be noted that to explain the process steps of the flowchart 300, references will be made to the system elements of the FIG. 1A, FIG. 1B and FIG. 2. The flowchart 300 initiates at step 302. At step 304, the fetching module 204a fetches the first set of parameters associated with the one or more advertisers 108, one or more publishers 106 and the one or more advertisements associated with the one or more advertisers 108. At step 306, the calculation engine 204b calculates the probabilistic effective cost per thousand impressions value for the second set of parameters based on the first set of parameters. The second set of parameters is associated with the one or more advertisers 108, the one or more publishers 106 and the one or more advertisements associated with the one or more advertisers 108. The effective cost per thousand impressions is calculated for the one or more advertisements associated with the one or more advertisers 108. At step 308, the priority setting module 204c ranks each of the plurality of advertisement campaigns associated with each of the one or more advertisers 108. The rank is assigned based on the probabilistic effective cost per thousand impressions value and the third set of parameters associated with each of the plurality of advertisement campaigns. Also, the ranking is performed for assigning the priority level to each of the plurality of advertisement campaigns. At step 310, the advertisement serving module 204d serves the one or more advertisements to the one or more users on the corresponding one or more publishers 106 based on the ranking of each of the plurality of advertisement campaigns. The served one or more advertisements corresponding to the one or more advertisers 108 is associated with the corresponding one or more advertisements campaigns of the plurality of advertisement campaigns having the highest rank and the priority. The flowchart 300 terminates at step 312.

It may be noted that the flowchart 300 is explained to have above stated process steps; however, those skilled in the art would appreciate that the flowchart 300 may have more/less number of process steps which may enable all the above stated embodiments of the present disclosure.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for facilitating optimized serving of one or more advertisements on one or more publishers, the computer-implemented method comprising:
fetching, with a processor, a first set of parameters associated with one or more advertisers, the one or more publishers and the one or more advertisements associated with the one or more advertisers;
calculating, with the processor, a probabilistic effective cost per thousand impressions value for a second set of parameters based on the first set of parameters, wherein the second set of parameters being associated with the one or more advertisers, the one or more publishers and the one or more advertisements associated with the one or more advertisers and wherein the effective cost per thousand impressions being calculated for the one or more advertisements associated with the one or more advertisers;
ranking, with the processor, each of a plurality of advertisement campaigns associated with each of the one or more advertisers, wherein the rank being assigned based on the probabilistic effective cost per thousand impressions value and a third set of parameters associated with each of the plurality of advertisement campaigns, wherein the ranking being performed for assigning a priority level to each of the plurality of advertisement campaigns and wherein the priority being assigned based on weights; and
serving, with the processor, the one or more advertisements to one or more users on the corresponding one or more publishers based on the ranking of each of the plurality of advertisement campaigns, wherein the served one or more advertisements corresponding to the one or more advertisers being associated with a corresponding one or more advertisements campaigns of the plurality of advertisement campaigns having a highest rank and priority and wherein the one or more advertisements being served in real time.

2. The computer-implemented method as recited in claim 1, further comprising dynamically updating, with the processor, the first set of parameters, the second set of parameters, the third set of parameters and the rank of each of each of the plurality of advertisement campaigns and wherein the updating being done in real time.

3. The computer-implemented method as recited in claim 1, wherein the first set of parameters comprises at least one of a name of each of the one or more advertisers, an advertiser ID of each of the one or more advertisers, an advertiser category of each of the one or more advertisers, an advertiser campaign information for each of the one or more advertisers, an advertiser campaign ID for each of the one or more advertisers, a banner type, a banner ID for each of the one or more advertisements, a publisher ID for each of the one or more publishers, name of an operating system associated with a portable communication device accessed by a user of the one or more users, time of impression request by the one or more publishers, an operating system version of the portable communication device accessed by the user of the one or more users, a publisher category for each of the one or more publishers and a network ID and wherein the advertiser category and the publisher category being determined by utilizing a binary identification.

4. The computer-implemented method as recited in claim 1, wherein the second set of parameters comprises at least one of an effective cost per thousand impressions for each banner ID on each publisher of the one or more publishers, an effective cost per thousand impressions for each of the one or more advertisers on each of the one or more publishers, an effective cost per thousand impressions for each of the one or more advertisers on each of one or more publisher categories associated with each of the one or more publishers, an effective cost per thousand impressions for each of one or more advertiser categories associated with the one or more advertisers on each of the one or more publishers, an effective cost per thousand impressions for each of the one or more advertiser categories on each of the one or more publisher categories, an effective cost per thousand impressions for each of one or more banners IDs on each of the one or more publishers, an effective cost per thousand impressions for each of the one or more banner IDs on each of the one or more publisher categories, an effective cost per thousand impressions for each of the one or more advertisers on each of one or more networks, an effective cost per thousand impressions of each of the one or more banner IDs on each of the one or more networks, an effective cost per thousand impressions of each of the one or more advertiser categories on each of the one or more networks, an effective cost per thousand impressions for each of one or more banner types on each of the one or more networks, an effective cost per thousand impressions for each of the one or more banner types on each of the one or more publishers and an effective cost per thousand impressions for each of the one or more banner types on each of the one or more publisher categories.

5. The computer-implemented method as recited in claim 1, wherein the third set of parameters corresponds to one or more properties associated with each of the plurality of advertisement campaigns, wherein the one or more properties associated with each of the plurality of advertisement campaigns comprises at least one of a daily event goal, a time limit for each of the plurality of advertisement campaigns and a set priority.

6. The computer-implemented method as recited in claim 1, further comprising storing, with the processor, the first set of parameters, the second set of parameters and the third set of parameters.

7. The computer-implemented method as recited in claim 1, wherein the calculation being performed based on a generation of a request from the one or more publishers.

8. The computer-implemented method as recited in claim 1, wherein the rank calculation when the daily event goal being provided for each of the plurality of advertisement campaigns being based on multiplication of a pre-defined factor and a cumulative effective cost per thousand impressions and wherein the pre-defined factor being based on a total number of events for each of the plurality of advertisement campaigns, a remaining number of events for each of the plurality of advertisement campaigns, total time for each of the plurality of advertisement campaigns and a remaining time for each of the plurality of advertisement campaigns.

9. The advertisement serving optimization system as recited in claim 1, wherein the one or more advertisements being displayed based on the effective cost per thousand impressions in a decreasing order of the effective cost per thousand impressions.

10. A computer-program product for facilitating optimized serving of one or more advertisements on one or more publishers, comprising:
a computer readable storage medium having a computer program stored thereon for performing the steps of:
fetching a first set of parameters with one or more advertisers, the one or more publishers and the one or more advertisements associated with the one or more advertisers;
calculating a probabilistic effective cost per thousand impressions value for a second set of parameters based on the first set of parameters, wherein the second set of parameters being associated with the one or more advertisers, the one or more publishers and the one or more advertisements associated with the one or more advertisers and wherein the effective cost per thousand impressions being calculated for the one or more advertisements associated with the one or more advertisers;
ranking each of a plurality of advertisement campaigns associated with each of the one or more advertisers, wherein the rank being assigned based on the probabilistic effective cost per thousand impressions value and a third set of parameters associated with each of the plurality of advertisement campaigns, wherein the ranking being performed for assigning a priority level to each of the plurality of advertisement campaigns and wherein the priority being assigned based on weights; and
serving the one or more advertisements to one or more users on the corresponding one or more publishers based on the ranking of each of the plurality of advertisement campaigns, wherein the served one or more advertisements corresponding to the one or more advertisers being associated with a corresponding one or more advertisements campaigns of the plurality of advertisement campaigns having a highest rank and priority and wherein the one or more advertisements being served in real time.

11. The computer-program product as recited in claim 10, further comprising dynamically updating the first set of parameters, the second set of parameters, the third set of parameters and the rank of each of each of the plurality of advertisement campaigns and wherein the updating being done in real time.

12. The computer-program product as recited in claim 10, wherein the first set of parameters comprises at least one of a name of each of the one or more advertisers, an advertiser ID of each of the one or more advertisers, an advertiser category of each of the one or more advertisers, an advertiser campaign information for each of the one or more advertisers, an advertiser campaign ID for each of the one or more advertisers, a banner type, a banner ID for each of the one or more advertisements, a publisher ID for each of the one or more publishers, name of an operating system associated with a portable communication device accessed by a user of the one or more users, time of impression request by the one or more publishers, an operating system version of the portable communication device accessed by the user of the one or more users, a publisher category for each of the one or more publishers and a network ID and wherein the advertiser category and the publisher category being determined by utilizing a binary identification.

13. The computer-program product as recited in claim 10, wherein the second set of parameters comprises at least one of an effective cost per thousand impressions for each banner ID on each publisher of the one or more publishers, an effective cost per thousand impressions for each of the one or more advertisers on each of the one or more publishers, an effective cost per thousand impressions for each of the one or more advertisers on each of one or more publisher categories associated with each of the one or more publishers, an effective cost per thousand impressions for each of one or more advertiser categories associated with the one or more advertisers on each of the one or more publishers, an effective cost per thousand impressions for each of the one or more advertiser categories on each of the one or more publisher categories, an effective cost per thousand impressions for each of one or more banners IDs on each of the one or more publishers, an effective cost per thousand impressions for each of the one or more banner IDs on each of the one or more publisher categories, an effective cost per thousand impressions for each of the one or more advertisers on each of one or more networks, an effective cost per thousand impressions of each of the one or more banner IDs on each of the one or more networks, an effective cost per thousand impressions of each of the one or more advertiser categories on each of the one or more networks, an effective cost per thousand impressions for each of one or more banner types on each of the one or more networks, an effective cost per thousand impressions for each of the one or more banner types on each of the one or more publishers and an effective cost per thousand impressions for each of the one or more banner types on each of the one or more publisher categories.

14. The computer-program product as recited in claim 10, wherein the third set of parameters corresponds to one or more properties associated with each of the plurality of advertisement campaigns, wherein the one or more properties associated with each of the plurality of advertisement campaigns comprises at least one of a daily event goal, a time limit for each of the plurality of advertisement campaigns and a set priority.

15. An advertisement serving optimization system for facilitating optimized serving of one or more advertisements on one or more publishers, the advertisement serving optimization system comprising:
a fetching module in a processor, the fetching module being configured for fetching a first set of parameters associated with one or more advertisers, the one or more publishers and the one or more advertisements associated with the one or more advertisers;
a calculation engine in the processor, the calculation engine being configured to calculate a probabilistic effective cost per thousand impressions value for a second set of parameters based on the first set of parameters, wherein the second set of parameters being associated with the one or more advertisers, the one or more publishers and the one or more advertisements associated with the one or more advertisers and wherein the effective cost per thousand impressions being calculated for the one or more advertisements associated with the one or more advertisers;
a priority setting module in the processor, the priority setting module being configured for ranking each of a plurality of advertisement campaigns associated with each of the one or more advertisers, wherein the rank being assigned based on the probabilistic effective cost per thousand impressions value and a third set of parameters associated with each of the plurality of advertisement campaigns, wherein the ranking being performed for assigning a priority level to each of the plurality of advertisement campaigns and wherein the priority being assigned based on weights; and
an advertisement serving module in the processor, the advertisement serving module being configured to serve the one or more advertisements to one or more users on the corresponding one or more publishers based on the ranking of each of the plurality of advertisement campaigns, wherein the served one or more advertisements corresponding to the one or more advertisers being associated with a corresponding one or more advertisements campaigns of the plurality of advertisement campaigns having a highest rank and priority and wherein the one or more advertisements being served in real time.

16. The advertisement serving optimization system as recited in claim 15, further comprising an updation engine in the processor, the updation engine being configured to dynamically update the first set of parameters, the second set of parameters, the third set of parameters and the rank of each of each of the plurality of advertisement campaigns and wherein the updating being done in real time.

17. The advertisement serving optimization system as recited in claim 15, wherein the first set of parameters comprises at least one of a name of each of the one or more advertisers, an advertiser ID of each of the one or more advertisers, an advertiser category of each of the one or more advertisers, an advertiser campaign information for each of the one or more advertisers, an advertiser campaign ID for each of the one or more advertisers, a banner type, a banner ID for each of the one or more advertisements, a publisher ID for each of the one or more publishers, name of an operating system associated with a portable communication device accessed by a user of the one or more users, time of impression request by the one or more publishers, an operating system version of the portable communication device accessed by the user of the one or more users, a publisher category for each of the one or more publishers and a network ID and wherein the advertiser category and the publisher category being determined by utilizing a binary identification.

18. The advertisement serving optimization system as recited in claim 15, wherein the second set of parameters comprises at least one of an effective cost per thousand impressions for each banner ID on each publisher of the one or more publishers, an effective cost per thousand impressions for each of the one or more advertisers on each of the one or more publishers, an effective cost per thousand impressions for each of the one or more advertisers on each of one or more publisher categories associated with each of the one or more publishers, an effective cost per thousand impressions for each of one or more advertiser categories associated with the one or more advertisers on each of the one or more publishers, an effective cost per thousand impressions for each of the one or more advertiser categories on each of the one or more publisher categories, an effective cost per thousand impressions for each of one or more banners IDs on each of the one or more publishers, an effective cost per thousand impressions for each of the one or more banner IDs on each of the one or more publisher categories, an effective cost per thousand impressions for each of the one or more advertisers on each of one or more networks, an effective cost per thousand impressions of each of the one or more banner IDs on each of the one or more networks, an effective cost per thousand impressions of each of the one or more advertiser categories on each of the one or more networks, an effective cost per thousand impressions for each of one or more banner types on each of the one or more networks, an effective cost per thousand impressions for each of the one or more banner types on each of the one or more publishers and an effective cost per thousand impressions for each of the one or more banner types on each of the one or more publisher categories.

19. The advertisement serving optimization system as recited in claim 15, wherein the third set of parameters corresponds to one or more properties associated with each of the plurality of advertisement campaigns, wherein the one or more properties associated with each of the plurality of advertisement campaigns comprises at least one of a daily event goal, a time limit for each of the plurality of advertisement campaigns and a set priority.

20. The advertisement serving optimization system as recited in claim 15, further comprising a database in the processor, the database being configured to store the first set of parameters, the second set of parameters and the third set of parameters.
